(19) United States
(12) Patent Application Publication
(10) Pub. No.: US 2010/0043108 A1
(43) Pub. Date: Feb. 18, 2010

(54) PROBE FOR SCANNING PROBE MICROSCOPE

(75) Inventors: Motoyuki Hirooka, Hitachi (JP); Makoto Okai, Tokorozawa (JP); Takafumi Morimoto, Abiko (JP); Satoshi Sekino, Ushiku (JP); Hiroki Tanaka, Takahagi (JP); Masato Takashina, Mito (JP); Yuuki Uozumi, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignees: Hitachi Construction Machinery Co., Ltd.; Hitachi Kyowa Engineering Co., Ltd.

(21) Appl. No.: 12/262,208

(22) Filed: Oct. 31, 2008

(30) Foreign Application Priority Data
Oct. 31, 2007 (JP) 2007-283764

(51) Int. Cl. G01B 5/28

(52) U.S. Cl. 850/57; 977/788

(57) ABSTRACT

In a tip having a carbon nanotube tip used to a scanning probe microscope, its length of the tip is adjusted in a several order of 10 nm and the tip maintains cylindrical shape up to the extremity portion.

### CLAIM OF PRIORITY

This application claims priority from Japanese patent application serial No. 2007-283764, filed on Oct. 31, 2007, the content of which is hereby incorporated by reference into this application.

### BACKGROUND OF THE INVENTION

The present invention relates to a probe having a tip formed from a nanotube, especially, a carbon nanotube, a manufacturing method for the tip, and a scanning probe microscope.

A high aspect ratio fine structure has been proposed according to the recent finer design of semiconductors and then accuracy of nanometer order has been required in the measurement techniques. The present miniaturization of the semiconductors goes into 45 nm node and the measurement becomes more and more difficult. At present, a scanning electron beam microscope (SEM) is used for observing a section of a semiconductor. Observation by the SEM is conventionally executed after making cleavage of a specimen or working a specimen by a focused ion beam (FIB). Such a method, however, has a specimen breakage problem, and therefore, new techniques applicable for a three-dimension measurement without damaging the specimen have been required.

A three-dimension measurement of semiconductors by a scanning tip microscopy (SPM) is focused as one resolution method. An atomic force microscopy (AFM) is one kind of surface condition measurement technique of using the SPM, and which measures a surface condition while contacting a tip to a surface of a specimen or non-contacting a prove to the specimen. In the AFM, it is required to prevent an individual shape difference in every tip fixed to the tip, and to provide high strength and long life to obtain a faithful shape measurement and high reproducibility.

Incidentally, in surface physical measurement methods excepting the AFM, that is, Kelvin force microscopy (KFM) for sensing a surface potential, magnetic force microscopy (MFM) for sensing a surface flux of magnetic field and chemical force microscopy for sensing a surface distribution of chemical functional groups, it is necessary to realize a high aspect of the tip for high resolution in surface physical property measurement because the tip aspect ratio has influences on its resolution, too.

In such situations, a corbon nanotube has been used as a tip of the AFM. A diameter of the carbon nanotube is quite small and the minimum diameter is about 1 nm. Moreover, the carbon nanotube is able to recover by its superior elasticity even if it received buckling and bending by a physical shock, and has advantages of high strength and a long lifetime as the tip. Therefore, the carbon nanotube is superior as the AFM tip.

A conventional AFM has been used mainly for observing a surface condition and roughness evaluation for the specimen. The AFM is also used for quantitative evaluation of a three dimensional structure due to appearing of the carbon nanotube tip. However, in the three-dimensional shape measurement, image distortion and noise cause by influence of force acting between the tip and specimen, as a result, the resolution faculty frequently decreases.

It is known that the problems are particularly remarkable in the case of the carbon nanotube tip. For example, in the measurement of the line and space, influences on image by adhesion to the side wall by Van der Waals' forces, tip sliding or bending become a problem of the measurement reliability, and the reproducibility of the measured image is also an important problem. To solve the problems, the tip is required to be no individual differences in every tip and tip shape adjustment is absolutely necessary.

Some methods for controlling the tip shape of the carbon nanotube have been proposed. On the other hand, the tip's length adjustment is usually carried out only by working the tip. It is easier than the method for adjusting the tip's diameter depending on the carbon nanotube manufacturing method. In particular, a method of cutting a carbon nanotube is primarily used in manufacturing of the tip. For example, a carbon nanotube tip manufacturing method in which a carbon nanotube is supported to the probe by using a manipulator in a scanning electron microscope and coated by carbon substances is disclosed in a Japanese patent 3,441,396. On the other hand, as other methods to adjust the length practically and suitably, methods for cutting away an end portion using an electrical discharge machining and a focused ion beam are described in Japanese laid open patent publications 2002-347000 and 2005-31958. These length adjustment methods have an advantage of sharpening the carbon nanotube tip, sufficiently.

### SUMMARY OF THE INVENTION

When lengths and diameters of the carbon nanotube tips are different from each other, individual differences of them occur and the resultant measured image is not reproduced correctly. Therefore, it is important to adjust rigidity of the tip by the length and diameter in the carbon nanotube tip. If end of the carbon nanotube tip, however, is too sharpened or uneven, the maximum tip rigidity obtained by certain value of the length and diameter is not secured.

Additionally, when the extremity end of the tip is sharpened, a region where the tip does not come into contact with the specimen surface occurs. This phenomenon is caused by convoluting the acute shape of the carbon nanotubes on a measurement display and obtaining no faithful measurement shape when a multiwalled carbon nanotube with diameter of 10-50 nm is used and the measurement object size is equal to or lower than the diameter of the carbon nanotube. For instance, line and space bottom roughness is considered. Furthermore, when the carbon nanotube tip having irregular diameter is worn out and the end potion diameter is changed, the image are also changed due to contact condition change with the specimen, and the resolution becomes difficult. This change makes quantitative evaluation of the specimen shape based on the AFM image difficult.

As described above, it will be required to form the carbon nanotube tip with a cylindrical shape throughout including its extremity portion to improve reliability and reproducibility of the measured image.

An object of the present invention is to provide a probe having a tip whose length is adjusted and whose shape is kept cylindrically up to the extremity portion for ensuring the tip rigidity when using a nanotube, especially, a carbon nanotube as the tip and improving reliability and reproducibility of the measured image, and to provide its manufacturing method as well as a scanning probe microscope.

One aspect of the present invention is to provide a probe having a nanotube tip shaped cylindrically.

Another aspect of the present invention is to provide a probe having a tip forming a flat face at the extremity portion.

Further aspect of the present invention is to provide a manufacturing method for a probe having a tip formed from a nanotube, wherein the nanotube tip is fixed to a tip holder and the tip is maintained cylindrical shape up to the extremity portion and its length is adjusted.

Still further aspect of the present invention is a scanning probe microscope having a probe with a nanotube tip and the tip is cylindrical shape up to the extremity portion.

The probe having a nanotube tip whose length is accurately adjusted and shape is kept a cylindrical shape up to the extremity portion is capable of ensuring the maximum tip rigidity by obtaining a certain value of the length and diameter. Accordingly, the tip becomes capable of capturing accurately side surface shape and the side surface of the specimen with large roughness in comparing the conventional device and improving reproducibility of the measured image of every nanotube tip.

### BRIEF EXPLANATION OF THE DRAWINGS

FIG. 1 is a perspective view showing a condition when a tip is arranged on a specimen surface in an embodiment of the present invention;

FIG. 2 is a schematic view showing a measurement condition by a tip in accordance with the present invention;

FIG. 3 is a view showing a condition when wearing out the end portion of the carbon nanotube by pressing it to the specimen;

FIG. 4 is a perspective view showing a condition when a tip is arranged on a specimen surface in other embodiment of the present invention;

FIG. 5 is a schematic view showing the measurement condition by a tip of a comparative example 1;

FIG. 6 is a schematic view showing the whole structure of the tip; and

FIG. 7 is a schematic view showing a measurement condition by a tip of a comparative example 2.

### DETAILED DESCRIPTION OF THE INVENTION

If the lengths and diameters of the nanotube tips differ from each other, individual differences of the nanotube tips caused in their rigidity and the measured image is not correctly reproduced. Therefore, it is important to control the rigidity of the tip by adjusting the length and diameter in the nanotube tip. It has, however, been clarified in the course of the present invention that when the nanotube tip is sharpened or uneven, the maximum tip rigidity obtained at a certain length and diameter is not ensured and a non-contact region of the tip is caused, accordingly, these problems on the measured image faithfulness and reproducibility are necessary to be solved.

The present invention solves the above problems by working the end portion as the extremity of the carbon nanotube so as to be cylindrical shape up to the extremity portion and forming flat surface, or selecting a cylindrical shaped carbon nanotube up to the extremity portion or a carbon nanotube with a flat face end portion to use as a tip.

The tip is desirable to maintain the cylindrical shape throughout the extremity portion, however, if maintaining the cylindrical shape up to at least the length of the order of the diameter from the extremity portion of the nanotube, there is no problem in the practical use.

The extremity portion is desirable to be flat throughout the whole region and there is no problem on the practical use if 80% of the whole region is flat.

The carbon nanotube may recover even if buckling or bending by a physical shock occurs, therefore, it is most suitable to be used as a tip in the present invention. Well-known carbon tubes, such as a multi-walled carbon nanotube, boron or nitrogen doped carbon nanotube, metal atoms and fullerene included nanotube, metal atoms and fine metal particle coated nanotube are available as the above carbon nanotubes.

The carbon nanotube is bonded along the tip holder. The tip holder is formed by cutting away an extremity portion of an original probe having a quadrangular pyramid shape, triangular pyramid shape, or cone shape so as to be able to neglect the unevenness of the extremity portion shape. As holder materials, it is desirable to use a material selected from silicon, silicon nitride, metal-coated silicon, or tungsten. In addition, when using a silicon based tip holder, a cantilever with a rear aluminum coating of reflection film may be available.

It is a preferable method to fix the carbon nanotube to the tip holder by depositing a metal layer from an arbitrary direction at an holder apex, particularly, fixing the tip by deposition so as to go round behind the tip at the holder apex is suitable for easy fixing and maintaining the position of the carbon nanotube. In addition, the fixing method for depositing the metal layer in the radial direction of the carbon nanotube is capable of fixing and bending the carbon nanotube and therefore, the fixing is easy to adjust the degree of the tip angle.

The metal deposition is preferable to be carried out by a method using an electron beam induced deposition. In this method, an electron radiation decomposes metal compound gas and a metal coating film formed by deposition of the resulting products fixes the carbon nanotube. Tungsten (W), gold (Au) and platinum (Pt) are available as the deposition materials. In the case of tungsten, the carbon nanotube and tip holder are contacted to each other and then heated-vaporized gas of W (CO) ₆ or WF₂ is introduced into a specimen room portion of a scanning electron beam microscope with high vacuum degree and then either the gas W (CO) ₆ or WF₂ is discharged with a nozzle around the contact portion. As a result, atmosphere of the gas is formed in the vicinity of the contact part between the tip and the holder, the electron beam is irradiated to the contact part to decompose the gas, and the separated tungsten is deposited on the contact portion, that is, the irradiation region.

To reduce hydrocarbon adhered to the carbon nanotube tip, it is preferable to set strength of an electron beam for decomposing gas within a predetermined range and deposit metal in a condition that the metal surrounds the carbon nanotube up to a rear side of the carbon nanotube. A strength of the electron is regulated according to acceleration voltage and emission current of the radiated electron beam. However, there is a tendency to deposit hydrocarbon as emission current becomes large. Therefore, the emission current is desirable to be less than 20 μA to reduce the hydrocarbon deposition value and provide metal deposition with sufficient strength.

A thickness of the metal layer is preferable to be thick enough to fix the carbon nanotube tip and concretely more than two times as thick as the diameter of the carbon nanotube. For example, in the case of 5 nm diameter carbon nanotube, the thickness of the metal layer is preferable to be more than 10 nm. As a result, the metal layer surrounds a circumference of the 10 nm thickness carbon nanotube and whole outside diameter is more than three times as large as the diameter of the carbon nanotube, that is, 30 nm.

It is desirable to deposit the metal layer so as to reduce a carbon nanaotube region exposing on the holder and maintain the carbon nanotube in a center of the holder. If the carbon nanotube is eccentrically positioned, there is a high possibility to cause break-down of the metal layer from its thinner portion.

A working method for keeping a cylindrical shape of the carbon nanotube up to its extremity portion is performed through the following process, that is, for example, contacting the extremity portion of the carbon nanotube fixed to the base material (tip holder) with the extremity portion of another carbon nanotube supported by an electrode, flowing a current between the tip holder and the electrode using capacitor discharge to cut a part of an extremity portion side of the carbon nanotube at the contact portion and repeating the above process.

Flowing pulse current is also capable of forming the carbon nanotube in the cylindrical shape in place of flowing current by a capacitor discharge.

The cutting for a part of the extremity portion side of the carbon nanotube is carried out by sublimating simultaneously the contact portion between them by the capacitor discharge current or pulse current. The cut region disappears partially, and a extremity face is obtained, which is made amorphous from the cut face up to the carbon nanotube layer thickness. In addition, obtained is an extremity portion having a shape of closed hole of the carbon nanotube or layers bonded to each other at the extremity portion. Such shape has an effect that prevents the nanotube itself from protruding toward the specimen side by the Van der Waal's force.

In a method of cutting the carbon nanotube by flowing a capacitor discharge current or pulse current, repetitive cuttings of several times enable to adjust precisely the length of the carbon nanotubes with accuracy of at least 50 nm. As the extremity portion of the carbon nanotube become amorphous after its cutting process, the repetitive cutting enables firstly to sublime easily the amorphous portion of the extremity portion. As the thickness of the vicinity of the cut face of the amorphous layer is nearly same level as that of the carbon nanotube, the cutting is capable of being done with accuracy of several 10 nm. This method is applicable to the multiwalled carbon nanotube with the size of about 50 nm and flattens the extremity portion shape by repeating the cutting process several times.

The voltage value of the capacitor discharge is preferable to be selected within a range from 1 (V) to 10 (V) and to be changed in accordance with an aspect ratio of the carbon nanotube fixed to the tip holder. For example, in the case of 20 nm diameter and 1-2 μm length carbon nanotube, the cutting process is carried out at a voltage from 2 (V) to 5 (V). A voltage alleviating time by the capacitor discharge has no influence on the cutting process and the cutting process is sufficiently performed if a rising current value is 10-100 μA.

It is possible to press the cut face of the carbon nanotube against a surface of the specimen at a constant pressure and move the carbon nanotube in the above and below direction and the right and left direction, thereby the cut face is worn out to the flattened face. In this method, when using in a contact mode of the scanning probe microscope, for example, the carbon nanotube tip is not worn out initially, and therefore, stable images are obtainable from beginning of the scanning.

When pressing the cut face of the carbon nanotube against the specimen surface to wear out, it is useful to form amorphous portion in flat. The carbon nanotube with amorphous-end face has a surface activity and it is capable of modifying metal. For example, when modifying a magnetic metal, such as cobalt, it may use for magnetic field imaging. In addition, all carbon nanotube constructed by crystalline has excellent anti-friction characteristics.

Other method for obtaining the carbon nanotube tip maintaining the cylindrical shape up to the extremity portion is, for example, selected among many carbon nanotubes.

It is undesirable to enlarge indiscriminately the aspect ratio, that is, the ratio of the diameter to the length of the carbon nanotubes, and preferable to adopt the aspect ratio to be less than 20 to more than 1. The Young's modulus of the carbon nanotube is about 1 TPa, and its spring constant becomes 0.5 N/m or less when the aspect ratio exceeds 20. Accordingly, the spring constant becomes equal to that of a tip with a low spring constant of about 0.1 N/m, as a result, bending of carbon nanotubes to the image remarkably appears and the scanning ability worsens.

A nanotube tip whose length is adjusted at an accuracy of several 10 nm and keeping cylindrical shape up to the extremity portion may ensure the maximum tip rigidity determined by its length and diameter. This enables to makes sure observation of the side surface unevenness shape as well as side surface roughness of the tip faithfully. As a result, it is able to improve the measured image reproducibility of every nanotube tip and to prevent the decrease of the productivity.

Additionally, when the tip is in the measuring condition, when the tip is fixed to the holder so as to be perpendicular to the specimen surface, it will be able to obtain the shape more accurately.

An example of AFM with a probe of this invention attaches a tip and contacts a specimen with a tip, and measures a surface state of the specimen by scanning over the specimen and has a feedback mechanism to move up and down the tip or a specimen so as to be a constant contact condition between the specimen and the tip. As a result, a surface state (for example, unevenness) of the specimen is measured based on a control signal. For example, this tip is applicable to a contact mode and dynamic mode for measuring shape or AFM using a Step-in mode.

Since the cylindrical shape of the tip is maintained up to the extremity portion, and thereby the adhesion and bending to the tip exert less influence on the tip, the tip of the present invention has higher reliability and reproducibility compared with an ordinary tip. Moreover, it is possible to apply to Kelvin force microscopy (KFM) observing the shape and electric potential on the surface of the specimen at the same time or the surface current flowing on the tip by changing the tip into a tip having electro-conductive metallic courting or tungsten.

In addition, the carbon nanotubes tip whose extremity becomes amorphous is applicable to a chemical force microscopy modifying chemically the amorphous portion to observe the surface distribution of the chemical functional group, and the shape and surface physical information on the nano region are obtained.

Moreover, it is possible to apply to not only the research but also to manufacture the product necessary for measuring highly accurate surface condition (inspection process) in the manufacturing process is required like semiconductors and hard disc drives (HDD), etc.

Referring to a drawing, an embodiment in accordance with the present invention is explained, below. The scope of the invention is not limited to the above. In addition, in an embodiment to show below, the same reference numerals are used to the same parts to omit repeating explanation.

### Embodiment 1

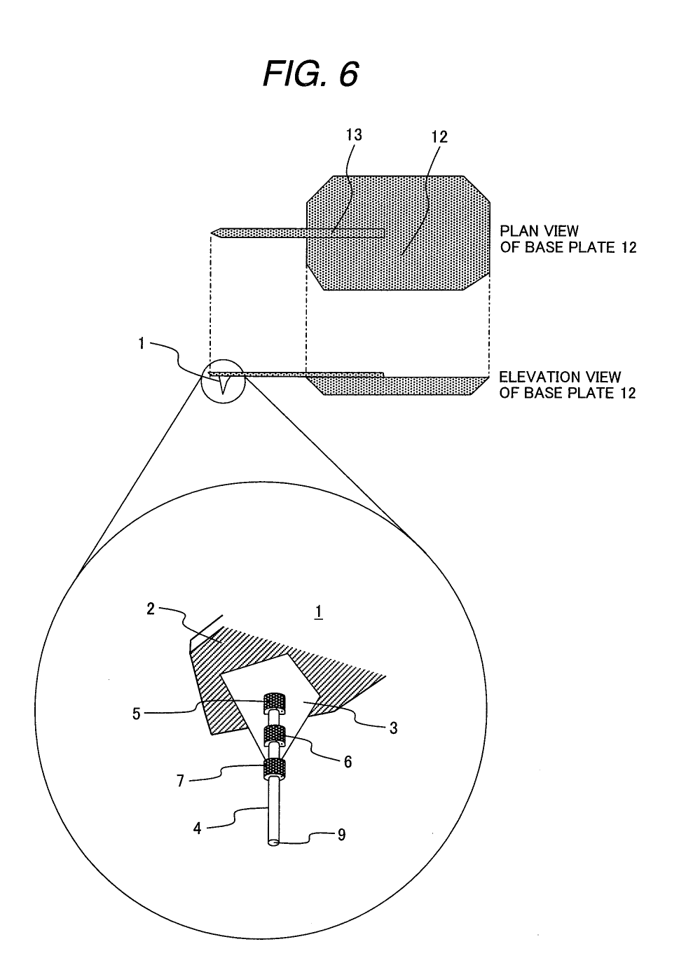

FIG. 6 shows the configuration of a scanning tip by an embodiment of this invention. In the scanning probe microscope of this embodiment, a cantilever 2 of a probe 1 is fixed to its base plate 12 as shown in a plan view and elevation view. The probe 1 comprises a carbon nanotube tip 4 having a flat end portion as the extremity, a tip holder 3 having a quadrangular pyramid shape for fixing the tip 4, and the cantilever 2 fixing the carbon nanotube tip 4. The carbon nanotube tip 4 is fixed to a ridge line of the tip holder 3 formed in the quadrangular pyramid shape at three portions, that is, a forward side joint 7, an intermediate joint 6 and a back side joint 5. An aluminum coating 13 is put on a rear surface of the cantilever 2.

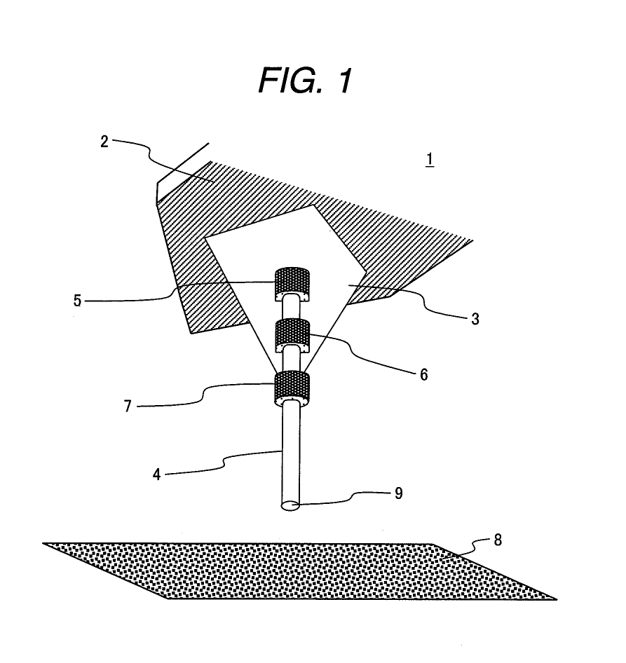

FIG. 1 shows a state that the carbon nanotube tip 4 of the probe 1 was arranged so as to be perpendicular to a specimen flat surface 8. The carbon nanotube tip 4 having uniformed diameter is fixed at first to the tip holder 3 at the back side joint 5 and intermediate joint 6 so as to be perpendicular to the flat surface of the specimen in the measurement state of the tip in this invention. Then, after confirming whether the carbon nanotube is perpendicular to the flat surface of the specimen and adjusting the arrangement, the carbon nanotube tip is finally fixed at the forward side joint 7. Afterwards, the extremity portion of the carbon nanotube is worked to form a flat face 9 of the extremity portion of the carbon nanotube.

It is able to bond the carbon nanotube to the tip holder 3 with sufficient reproducibility and same angle by bonding the carbon nanotube tip 4 along the ridge line or the surface of the tip holder 3.

The tip holder 3 has a quadrangular pyramid shape, a triangular pyramid shape, or a cone shape for the nanotube like a silicon tip or tungsten tip available in the market, and an extremity portion of the holder 3 is cut away so as to be able to neglect unevenness in the extremity portion shape. It is desirable to use silicon, silicon nitride, metal coated silicon or tungsten as materials of tip holder 3. Here, silicon was used as a material of the tip holder 3 and rear aluminum coat 13 was used on the back of the cantilever 2 of a silicon base as a reflection membrane to prevent charge up by the electron beam again.

Fixing the carbon nanotube tip 4 to the tip holder 3 was performed by bonding the carbon nanotube supported on the tip holder 3 by each metal layer deposition at the back side joint 5, forward side joint 7 positioned at the apex of the holder 3, and an intermediate joint between the back side joint 5 and the forward side joint 7. Concretely, a metal layer was gone round at the holder apex and deposited in the radial direction of the carbon nanotube from all directions of 360 degrees, namely, every direction while bending the carbon nanotube and adjusting its angle.

The metal layer deposition was carried out by using an electron beam deposition. Here, the fixing of the tip was performed using metal coating film formed by decomposing metal compound gas by an electron beam radiation and depositing its product. Additionally, tungsten was used as a deposition product.

For reduction of adhesion of the hydrocarbon to the carbon nanotube tip 4, the electron beam strength for decomposing the gas was set to an acceleration voltage 5-15 kV and emission current 10-20 μA to perform sedimentation of the tungsten. The metal layer was thickened in a degree enough to fix the tip. The thickness was adjusted in sufficient thickness to deposit of the tungsten used here in a box shape of 100×100 nm by the electron beam irradiation of 5-30 seconds.

The adjustment of the length of the carbon nanotube tip 4 was carried out by contacting its end portion with an end portion of another carbon nanotube supported to an electrode, and flowing current by capacitor discharge between the tip holder 3 and the electrode to cut a part of the extremity portion side of the nanotube. The method is able to obtain a carbon nanotube tip maintaining a cylindrical shape upto the top end portion.

A circuit including a capacitor for charging electrons between the tip holder 3 and an electrode, and a DC power source for supplying electrons to the capacitor can changes over the charging and discharging each other by a switch. At this time, the discharge of the capacitor is from a range of 1 V to 10 V, and was changed according to the aspect ratio of the carbon nanotube fixed to the tip holder 3.

It is capable of repeating the cut-off process plural times and flattening the end face of the extremity portion of the tip while cutting in a pitch of several tens nm.

In addition, 20 nm diameter carbon nanotubes were selected and adjusted to 50 to 400 nm length by cutting.

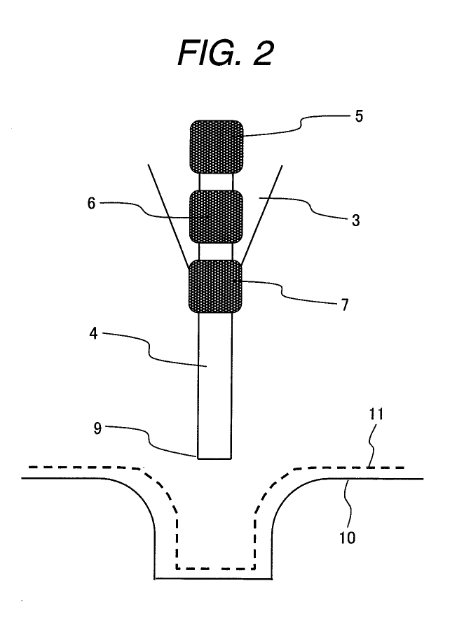

FIG. 2 shows a measurement state of a line and space 10 of the scanning probe microscope having the probe 1 constituted by the above method. For example, the tip of the present embodiment will be available for the AFM using, for example, contact mode for measuring shape, dynamic mode or step-in modes. In addition, as the carbon nanotube tip 4 of this embodiment is small, that is, lower than aspect ratio 20, it is hard to be affected by adhesion. Besides, a measured image profile 11 is obtained reflecting true shape 10 of bottom edges of the line and space because the tip is formed cylindrically up to the extremity portion.

If the tip of the present embodiment is changed to a conductive tip such as metal coated silicon or tungsten (W), a Kelvin Force microscope (KFM) observing simultaneously shape measurement and surface potential is usable and also, capable of measuring specimen surface current.

### Embodiment 2

When cutting a part of the extremity portion side of the carbon nanotube tip by flowing a current by the capacitor discharge, the end surface portion becomes amorphous throughout the thickness of the carbon nanotube layer.

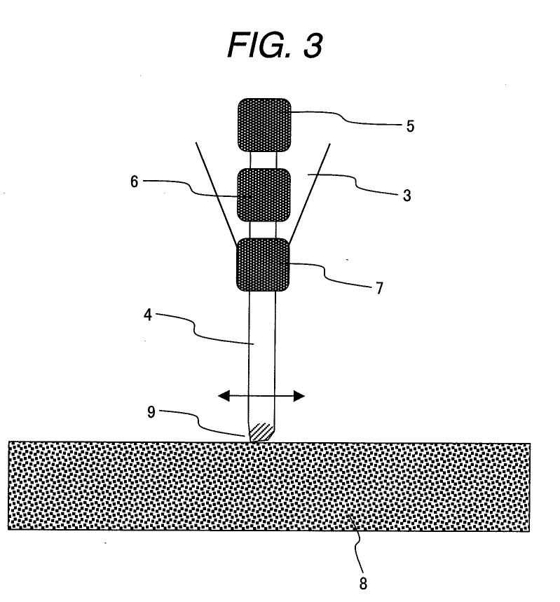

FIG. 3 shows a case of pressing the end portion of the carbon nanotube tip with a certain constant pressure to the flat surface of the specimen and scanning in a direction as shown by an arrow to wear out it. The aspect ratio of the carbon nanotube tip is adjusted by repeating cutting at several times by the capacitor discharge. For example, when being used in a contact mode, a carbon nanotube tip is not initially worn out and stable images are obtainable from beginning of scanning.

### Embodiment 3

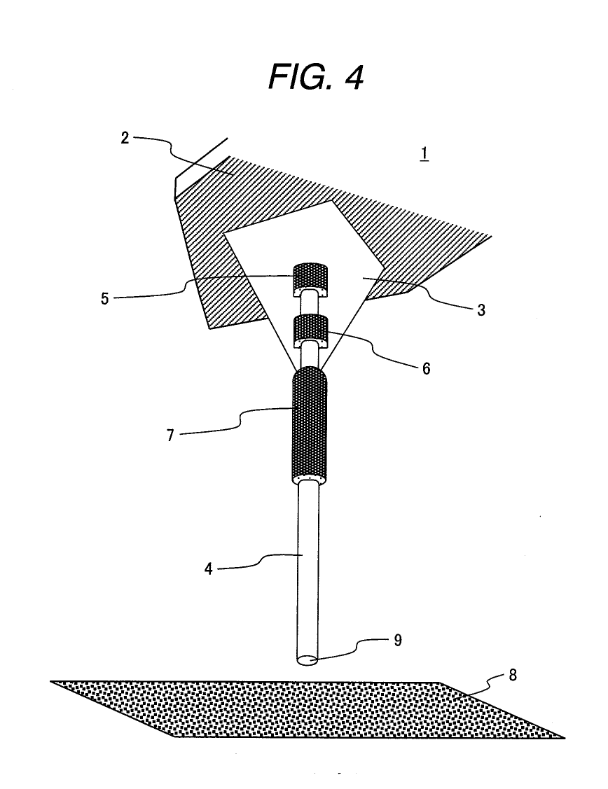

FIG. 4 is a perspective view of the carbon nanotube tip by the other embodiment of this invention. This embodiment used a carbon nanotube having uniform diameter and a flat end portion selected from many carbon nanotubes as a tip. At first, the tip was fixed at the back side joint 5 and intermediate joint 6 and then an angle of the tip was adjusted so as to be perpendicular against the specimen flatness surface 8 in the measurement state, and fixed at the forward side joint 7.

The aspect ratio of the tip is obtained from the ratio of the length from the forward side joint 7 to the diameter of the nanotube. In this embodiment, the width of the forward side joint 7 was lengthened to adjust the aspect ratio. In addition, the end bonding portion 7 is formed by the metal layer surrounding the carbon nanotube so as to go round in the radial direction of the carbon nanotube by 360 degrees.

### Comparative Example 1

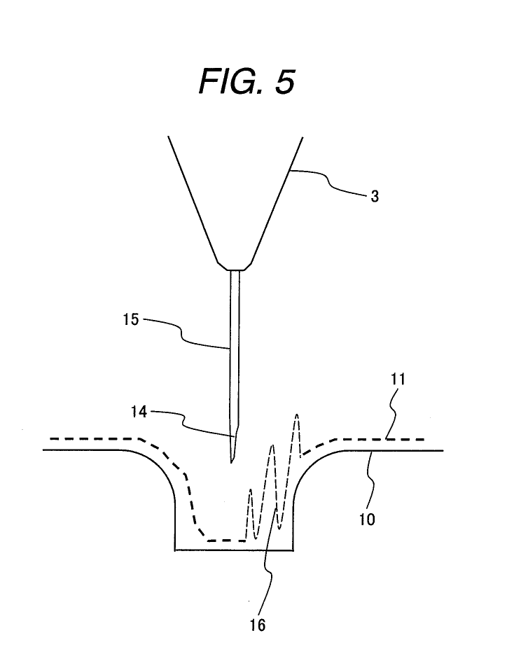

FIG. 5 is a schematic diagram when carrying out the measurement by a scanning probe microscope having a high aspect carbon nanotube tip 15 with a large aspect ratio.

If the aspect ratio is too high, the carbon nanotube tip is bent by adhesion and slip on the sidewall of the specimen. Therefore, due to this bending, the image noise 16 causes. The influence of the noise makes it difficult to detect the sidewall shape, faithfully.

### Comparative Example 2

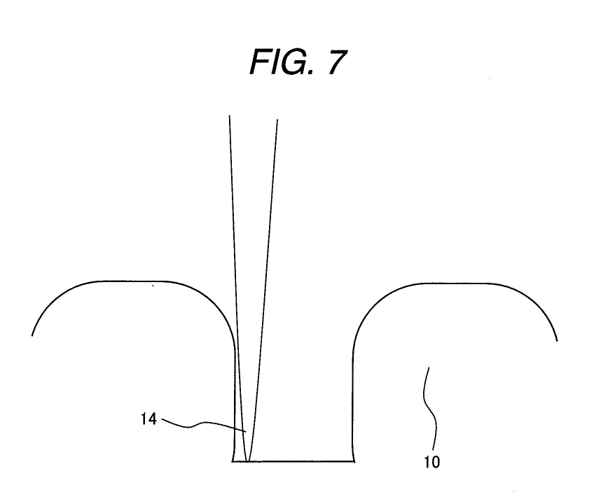

As shown in FIG. 7, a measured image profile 11 occurs because the region that is not detected with the side shape when the top end portion shape of polygon is sharpened or completely uneven. For example, the carbon nanotube having a sharpened shape 14 is made by a method to evaporate one by one by flowing current from an outer layer of the carbon nanotube. A method to cut off the carbon nanotube by the focused ion beam may manufacture it, but the top end portion of the tip becomes spherical. It is difficult for this case to detect the side shape faithfully because the carbon nanotube tip narrows toward the top end portion in both methods.

What is claim is:

1. A probe for a scanning probe microscope comprising a tip formed from a nanotube, wherein said tip has a cylindrical shape in form up to its extremity portion.

2. The probe according to claim 1, wherein the extremity portion of said tip has a flat end face.

3. The probe according to claim 1 or 2, said nanotube used for said tip is a carbon nanotube.

4. The probe according to claim 3, wherein the extremity portion of said tip formed from said a carbon nanotube is in an amorphous state.

5. The probe according to claim 3, wherein all of said tip formed from said a carbon nanotube is in a crystalline state, including the extremity portion.

6. The probe according to claim 1 or 2, wherein said tip formed from said nanotube is fixed to a tip holder by depositing a metal layer.

7. The probe according to claim 3, wherein said tip formed from said carbon nanotube is fixed to a tip holder made of a material selected among silicon (Si), nitro-silicon (SiN), metal coated silicon or tungsten (W).

8. A method for manufacturing a tip formed from a nanotube, comprising steps of:
fixing said nanotube-tip to a tip holder and working said nanotube-tip so as to take on a cylindrical shape up to an extremity portion of said tip.

9. The method for manufacturing said tip according to claim 8, wherein
said nanotube-tip is formed from a carbon nanotube; and
said carbon nanotube is fixed to a tip holder at said step of working said carbon nanotube and then cut a part of an extremity portion side of said carbon nanotube by flowing current through said carbon nanotube and repeating such cutting process for said carbon nanotube at plural times to regulate the length of said carbon nanotube while keeping a cylindrical shape in form up to the extremity portion of said carbon tip.

10. The method for manufacturing said tip according to claim 8, wherein
said nanotube-tip is formed from a carbon nanotube; and
said method further comprises steps of cutting a part of an extremity portion side of said carbon nanotube said carbon nanotube by flowing through said carbon nanotube, then pressing a cut face as an end face of said carbon nanotube against a flat face member and moving said carbon nanotube on said flat face member relatively to wear out said cut face; thereby flattening said cut face.

11. The method for manufacturing said tip according to claim 10, wherein said cut face of said carbon nanotube is worn out within a range where amorphous portion is remained to make said amorphous remain at the extremity portion of said carbon nanotube.

12. The method for manufacturing said tip according to claim 10, wherein said cut face is worn out until amorphous portion is disappeared so as to make all of said tip takes on a crystalline carbon nanotube.

13. The method for manufacturing said tip according to the claim 8, wherein
said tip holder has a quadrangular pyramid shape, triangular pyramid shape or corn shape whose top is cut out;
said nanotube-tip is fixed to a ridge line portion or a flat portion of said tip holder, and
cutting process for said nanotube-tip is carried out in a state of fixing said nanotube-tip to the edge line portion or the flat potion of said tip holder.

14. The method for manufacturing said tip according to claim 8, wherein fixing of said nanotube-tip to said tip holder is carried out by forming a metal layer by an electron beam deposition.

15. A scanning probe microscope comprising a tip formed from a nanotube, wherein said tip has a cylindrical shape in form up to its extremity portion.

16. The sccaning tip microscope according to claim 15, wherein said nanotube used for said tip is a carbon nanotube.

17. The scanning probe microscope according to claim 16, wherein the extremity portion of said tip formed from said a carbon nanotube is in an amorphous state.

18. The scanning probe microscope according to claim 16, wherein the extremity portion of said tip formed from said a carbon nanotube is in a crystalline state.

19. The scanning probe microscope according to claim 15, wherein said tip is fixed to said tip holder so as to be proximately perpendicular to a specimen when the tip is under measuring condition.
